(19) United States
(12) Patent Application Publication
(10) Pub. No.: US 2008/0209422 A1
(43) Pub. Date: Aug. 28, 2008

(54) Deadlock avoidance mechanism in multi-threaded applications

(76) Inventor: Joseph A. Coha, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/712,763

(22) Filed: Feb. 28, 2007

(51) Int. Cl. G06F 9/50

(52) U.S. Cl. 718/102

(57) ABSTRACT

A computer-implemented method for implementing a deadlock avoidance mechanism to prevent a plurality of threads from deadlocking in a computer system wherein a first thread of the plurality of threads request for a first resource is provided. The computer-implemented method includes employing the deadlock avoidance mechanism to intercept the request. The computer-implemented method also includes examining a status of the first resource. The computer-implemented method further includes, if the first resource is owned, identifying an owner of the first resource, analyzing the owner of the first resource to determine if the owner of the first resource is requesting a second resource, and analyzing the second resource to determine if the second resource is owned by the first thread. The computer-implemented method yet also includes, if the first thread owns the second resource, preventing deadlocking by handling a potential deadlock situation.

### BACKGROUND OF THE INVENTION

In a computer system, resources are limited and application actions (e.g., processes, threads, etc.) may be competing for the same resources. To prevent two or more application actions from concurrently modifying the same resources and causing data/file corruption, a lock may be employed. As discussed herein, a lock refers to a synchronization mechanism for regulating resource access in a computer system.

Locks may include memory words that may be employed to control access to a region of executable instructions (i.e., critical sections) that may be employed to modify contents of physical memory in the hardware level. During the execution of an application program, multiple actions may be occurring concurrently. Usually, locks may be employed to maintain consistency in a program state by allowing only one executable entity to modify the program state at any given time. The implementation of locks may help minimize data/file corruption and maintain proper program state.

Consider the situation wherein, for example, a thread wants to acquire a lock. If the thread is successful in acquiring the lock, then the thread is considered as the owner of the lock and may execute the instructions in the critical section. Upon completion of processing of the critical section, the thread may relinquish ownership of the lock. However, if the lock acquisition is not successful, the thread may have to wait for the lock to be relinquished before entering the critical section protected by the requested lock.

During the wait, the thread may enter a sleep state in the operating system layer. The thread may sleep until the thread receives a notification from the owner of the requested lock that the lock is available for acquisition. Although the implementation of locks may help minimize data/file corruption and maintain proper program state, the use of locks in an application program may create a processing condition known as deadlock. In a deadlock situation, two or more application actions, each of which possesses at least one lock, are waiting for another application action to release a lock. However, in a deadlock situation, notification may never occur. In a deadlock situation, the application actions may continue to “sleep” in an uninterruptible state until either the application program is killed or the computer system is shut down.

The computer industry has spent time and resources trying to prevent or handle deadlocks. One preventive solution includes implementing an ordered lock acquisition method. With an ordered lock acquisition method, the lock acquisition is arranged such that each lock must be acquired in sequence. In an example, lock 1 must be acquired before lock 2 may be acquired, even if the application action does not need lock 1 to execute.

The ordered lock acquisition method may prevent deadlock; however, the method may require that each lock in the computer execution environment be known and be arranged in sequence. The ordered lock acquisition method may be difficult to implement in a dynamic environment, especially an environment in which new components may be added to an application and current applications may be updated with new or modified features. Keeping track of the locks may be a tedious and time-consuming process. Further, the task of determining the sequence of the locks may be a challenging process that ordinary users may lack the skillset to implement.

Another method for handling deadlock situations may include a deadlock snoop method. The deadlock snoop method refers to a deadlock detection method employing resources (separate processes or threads in a process) to monitor the state of the application's execution. Once a deadlock has occurred, the deadlock snoop method may be employed to detect and handle the deadlock. To handle the deadlock, the deadlock snoop method may maintain a dynamic list of existing locks, the status of the locks, and the owner of the locks. Usually, the implementation of the deadlock snoop method is performed at the operating system level (i.e., below the user level). Maintaining a dynamic list can be an expensive resource intensive process. If a deadlock is determined to be present, the deadlock snoop method may analyze the deadlock to determine which application action to kill in order to stop the deadlock situation. Since a deadlock situation usually involves two or more application actions in an uninterruptible state, the deadlock snoop method may require the daunting and undesirable task of manipulating the internal state of an operating system in order to release one or more locks from a deadlock situation.

### SUMMARY OF INVENTION

The invention relates, in an embodiment, to a computer-implemented method for implementing a deadlock avoidance mechanism to prevent a plurality of threads from deadlocking in a computer system wherein a first thread of the plurality of threads request for a first resource. The computer-implemented method includes employing the deadlock avoidance mechanism to intercept the request. The computer-implemented method also includes examining a status of the first resource. The computer-implemented method further includes, if the first resource is owned, identifying an owner of the first resource, analyzing the owner of the first resource to determine if the owner of the first resource is requesting a second resource, and analyzing the second resource to determine if the second resource is owned by the first thread. The computer-implemented method yet also includes, if the first thread owns the second resource, preventing deadlocking by handling a potential deadlock situation.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a block diagram of a computer execution environment.

FIG. 2 shows an example of multiple application actions competing for the same resources.

FIG. 3A shows, in an embodiment of the invention, a simple block diagram illustrating an implementation of a deadlock avoidance mechanism.

FIG. 3B shows, in an embodiment of the invention, a simple flow chart illustrating a method for implementing the deadlock avoidance mechanism.

FIG. 3C, shows in an embodiment, a simple flow chart that may be performed on systems with larger numbers of threads in which locks may be associated with one or more blocked threads in a potential circular chain (i.e., potential deadlock).

FIG. 4 shows, in an embodiment, a simple block diagram illustrating an automatic method that may be implemented to handle potential deadlock situation.

FIG. 5A and 5B show, in embodiments of the invention, simple flow charts illustrating methods for unwinding a thread.

FIG. 6 shows, in an embodiment of the invention, a simple block diagram illustrating a notification method for handling potential deadlock situation.

FIG. 7 shows, in an embodiment of the invention, a simple flow chart example of the method described in FIG. 6.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

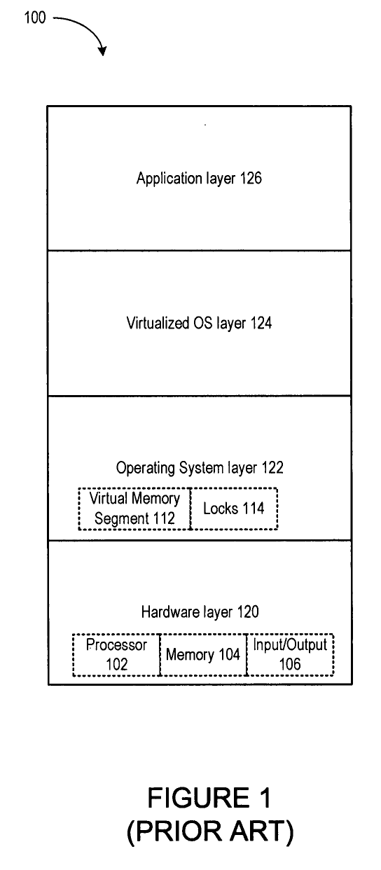

As aforementioned, locks may include memory words that may be employed to protect one or more critical sections of a computer system by limiting application actions access. To facilitate discussion, prior art FIG. 1 shows a block diagram of a computer execution environment. A computer execution environment 100 may include a plurality of hardware/software fundamental execution units (e.g., a hardware layer 120, an operating system layer 122, a virtualized operating system layer 124, and an application layer 126). Hardware layer 120 may include the physical components (e.g., a processor 102, a memory 104, input/output components 106, etc.) of a computer system. Operating system (OS) layer 122 is a virtual hardware layer that is responsible for managing the hardware and software resources of a computer system. Virtualized OS layer 124 is a runtime environment (e.g., Java runtime environment or Common Language Interface/Common Language Runtime) that presents an interface to application layer 126 of the operating system services in OS layer 122.

Consider the situation wherein, for example, an application program at application layer 126 is being executed. Virtualized OS layer 124 may include a single application programming interface (API) to enable the application program to be ported between different operating systems or versions of the operating systems. For each application program, OS layer 122 may have a virtual memory segment 112 composed of words of memory that may be allocated for use by the execution of the application program. OS layer 122 may also include locks 114.

The implementation of locks 114 may help minimize data/file corruption and maintain proper program state. A critical section may include a set of instructions that an application action may employ to modify program state, including, but are not limited to, modifying virtual memory 112 and underlying physical memory 104 of hardware layer 120. Memory 104 may be internal storage (e.g., random access memory, read-only memory, etc.) that may be employed to store data that may be actively accessed by processor 102.

During processing, application programs may have multiple actions occurring concurrently. In an example, multiple threads may be executing machine instructions simultaneously during processing. Each thread may access through OS layer 122, segments of memory 104, control structures in hardware layer 120, and/or operating system layer 122.

Application writers may employ locks to control access to a region of executable instructions, (i.e., critical sections) that may be employed to modify contents of memory 104. Usually, locks may be employed to maintain consistency of program state by allowing only one executable entity to modify the program state at any given time. In an example, locks 114 may be employed to minimize the possibility of data/file corruption in segments of memory 104 that may require, for example, special handling since only one thread may modify the contents of the segments of the memory.

When a thread attempts to enter a critical section protected by a lock, the thread may attempt to acquire the lock. If successful in lock acquisition, the thread is said to own the lock. The thread may then execute the instructions in the critical section and, when processing of the critical section is completed by the thread, the lock may be released (ownership relinquished). However, if the lock acquisition is not successful, the thread may have to wait to enter the critical section protected by that lock.

Consider the situation wherein, for example, thread 2 is trying to acquire a lock. If thread 2 is successful in acquiring the lock, then thread 2 is considered the owner of the lock and may execute the instructions in the critical section protected by that lock. Upon completion of processing of the critical section, thread 2 may relinquish ownership of the lock. However, if the lock acquisition is not successful, thread 2 may have to wait for the lock to be relinquished before entering the critical section protected by the requested lock. In this example, since thread 1 currently owns the lock, thread 2 may have to wait until thread 1 relinquishes the lock.

Usually, if the wait is long, thread 2 may enter a “sleep state” in operating system layer 122. When thread 1 completes execution of the critical section protected by the lock, thread 1 may notify the sleeping thread (e.g., thread 2) through operating system layer 122 that the lock is available. Thread 1 may release the lock and thread 2 may acquire the relinquished lock and begin execution.

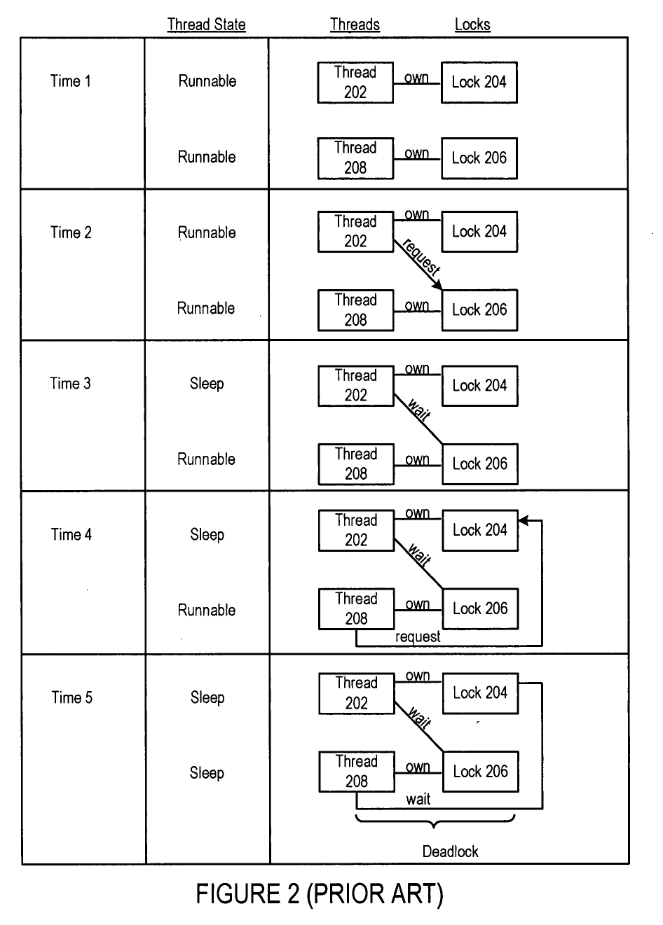

The implementation of locks may help minimize data/file corruption and maintain proper program state; however, the utilization of locks in an application program may create a processing condition known as deadlock. In a deadlock situation, two or more application actions, each of which possesses at least one lock, are waiting for the other application action to release a lock. Prior art FIG. 2 shows an example of multiple application actions competing for access to the same resources.

Consider the situation wherein for example, two threads arc competing for the same resources. Threads 202 and 208 may each own a lock 204 and a lock 206, respectively (at time 1). Locks 204 and 206 may be mutual exclusion (mutex) resources. In other words, each lock (e.g., lock 204 and lock 206) may only be assigned to one application action at a time. As discussed herein, a mutex refers to special words and/or conditional variables to control access to critical sections of executable machine instructions for the computer system. Usually, deadlock may occur when application actions try to access locks that are mutexes.

As time progresses (at time 2), thread 202 may request ownership for lock 206. However, since lock 206 is currently owned by thread 208, thread 202 must wait to acquire lock 206. In other words, for thread 202 to continue execution, thread 202 must wait for thread 208 to release lock 206. While waiting, thread 202 may stop execution by entering into a sleep state (at time 3) until a notification is sent by thread 208. In an ideal situation, thread 208 may release lock 206 upon completion of execution and notify thread 202 of the availability of lock 206.

Usually an application action that is waiting for a mutex to be released is notified when a mutex has been relinquished by another application action. However, in a deadlock situation, notification may never occur. In a deadlock situation, the application actions may continue to “sleep” in an uninterruptible state until either the application program is killed or the computer system is shut down.

In an example, after a time period (at time 4), thread 208 may now request ownership for lock 204. However, since lock 204 is currently owned by thread 202, thread 208 must stop processing until lock 204 has been released. Since both threads 202 and 208 are in an acquiring state and are waiting on each other to release a lock, a circular chain has occurred in which neither thread can complete processing (at time 5). As a result, a deadlock situation has arisen and both threads go into an uninterruptible sleep state. The examples described in FIG. 2 provide a simple example of how a deadlock situation may arise. Potentially, more complex interactions between the execution entities (e.g., threads) may also cause deadlock to occur.

Many modern computer systems arc capable of detecting a deadlock situation. However, once the deadlock situation has occurred, the executing code at the user level of the software stack is usually unable to recover from the deadlock. A reason for the inability to recover from the deadlock is because the primitives employed to implement the locking, which arc usually in operating system layer 122 and/or hardware layer 120, usually do not allow external notification of the thread waiting (e.g., thread 202 and thread 208 at time 5) to enter the critical section to continue execution. Instead, the current lock owner is usually the only one able to initiate the notification, which is part of the process of relinquishing ownership of the lock. Furthermore, even if one of the threads participating in a deadlock is able to begin execution prior to receiving notification, the thread resuming execution usually begins by entering the critical section protected by the lock. Thus, the reason for utilizing a lock to protect a critical section is violated and a race condition is created in which the threads are competing for shared program resources. In such a situation, the program state may become inconsistent and corruption (e.g., data corruption) may occur.

In one aspect of the invention, the inventor herein realized that handling an application action (e.g., thread, process, etc.) in an interruptible state is much easier than handling an application action in an uninterruptible sleep state. Generally, an application action in an interruptible state may be handled without requiring the internal state of an operating system to be rewritten.

The inventor also realized that an uninterruptible sleep state may be avoided by preventing a deadlock situation. To prevent a deadlock situation, a mechanism is needed to identify situations that may create deadlock situations.

In accordance with embodiments of the present invention, a deadlock avoidance mechanism is provided for identifying potential deadlock situations. Embodiments of the invention include analyzing each thread that is requesting a lock before allowing the requesting thread to acquire the requested lock. Embodiments of the invention further include efficient and lightweight methods for handling potential deadlock situations.

In this document, various implementations may be discussed using threads as an example. This invention, however, is not limited to threads and may include any action that an application program may employ. Instead, the discussions are meant as examples and the invention is not limited by the examples presented.

Also, in this document, various implementations may be discussed using a specific lock type, such as a mutex, as an example. This invention, however, is not limited to the specific lock scenario and may include other types of locks. Instead, the discussions are meant as examples and the invention is not limited by the examples presented.

Consider the situation wherein, for example, two threads are competing for the same resource. In an example, thread 1 and thread 2 each currently possesses lock 1 and lock 2, respectively. Thread 1 is also in an uninterruptible sleep state since thread 1 is waiting for thread 2 to release lock 2. Thread 1 has now become a blocked thread. After some time has passed, thread 2 may request ownership of lock 1.

In the prior art, the scenario described above may have created a deadlock situation. In an embodiment of the invention, a deadlock avoidance mechanism provides a method for identifying a potential deadlock situation. In an embodiment, the deadlock avoidance mechanism is a set of executable code that may be executed by each thread. In one embodiment, the executable code may run in a user mode privilege level enabling the deadlock avoidance mechanism to access data structures in the virtualized OS layer. By employing the deadlock avoidance mechanism, the system may intercept the request by thread 2. In an embodiment, the deadlock avoidance mechanism may analyze the thread (thread 2) to determine if the request for lock 1 may cause a potential deadlock situation. If a potential deadlock situation may occur, then the thread (thread 2) is prevented from acquiring the lock, thus circumventing a deadlock situation.

Not only is a deadlock situation avoided, but an embodiment of the invention also provides methods for waking a blocked thread (thread 1) in an uninterruptible sleep state. Generally, to wake a blocked thread from an uninterruptible sleep state, the blocked thread may need to receive a notification that the requested lock is now available.

In an embodiment of the invention, a lock may be released automatically. The lock may be automatically released by automatically unwinding each frame of a thread's stack. A frame may be a representation of the local data area for a function called as a thread executes machine instructions. For each thread, multiple frames may exist. Thus, unwinding a frame may involve undoing each function call, in an embodiment. In an embodiment, the ownership of each lock held by the thread and associated with a specific frame may also be released. Likewise, any clean-up code associated with exiting from a critical section protected by the locks for which ownership has been relinquished may also be executed. In an embodiment, each frame of a thread may be unwound until ownership of a requested lock is released. In another embodiment, all frames of a thread may be unwound.

In an embodiment of the invention, a deadlock event notification method may be employed to release a lock. In the deadlock event notification method, an identification of a potential deadlock situation may result in a notification being sent to an administrator. In a single process executing with multiple threads, the administrator may employ a deadlock administration thread to handle the potential deadlock situation. By utilizing the deadlock administration thread, decisions about which thread to unwind may be performed by the administrator. Also, the decision about how many frames may be unwound may also be handled by the administrator using the deadlock administration thread.

The features and advantages of the present invention may be better understood with reference to the figures and discussions that follow.

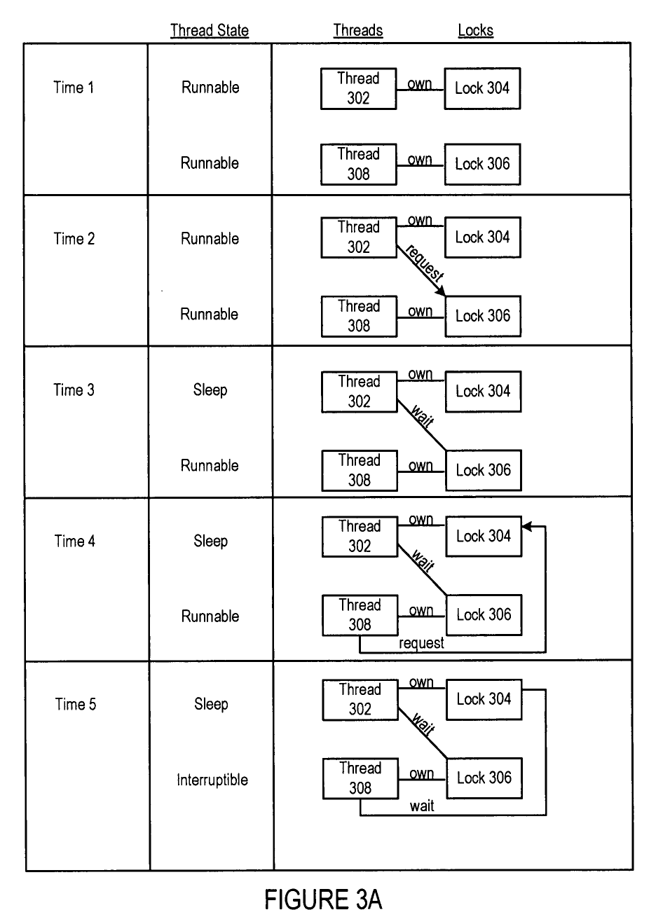

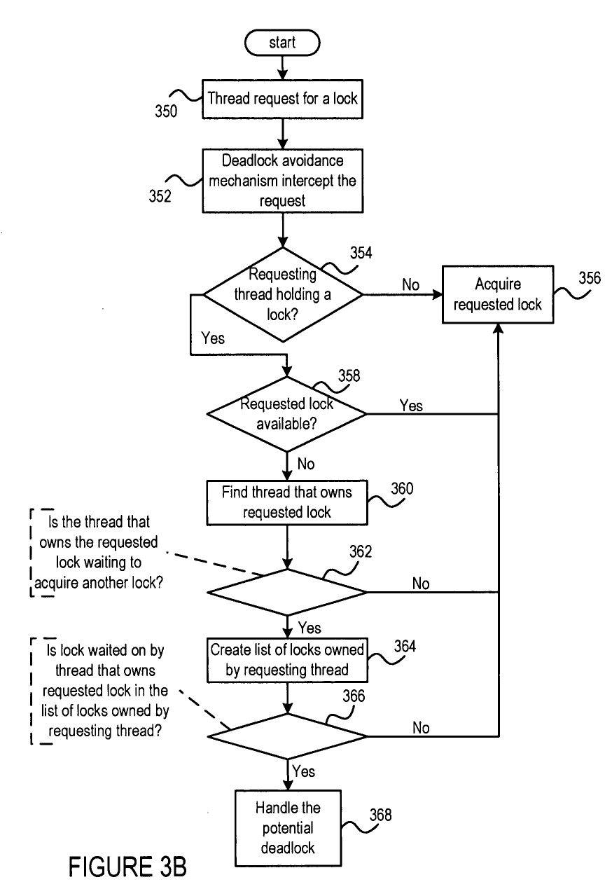

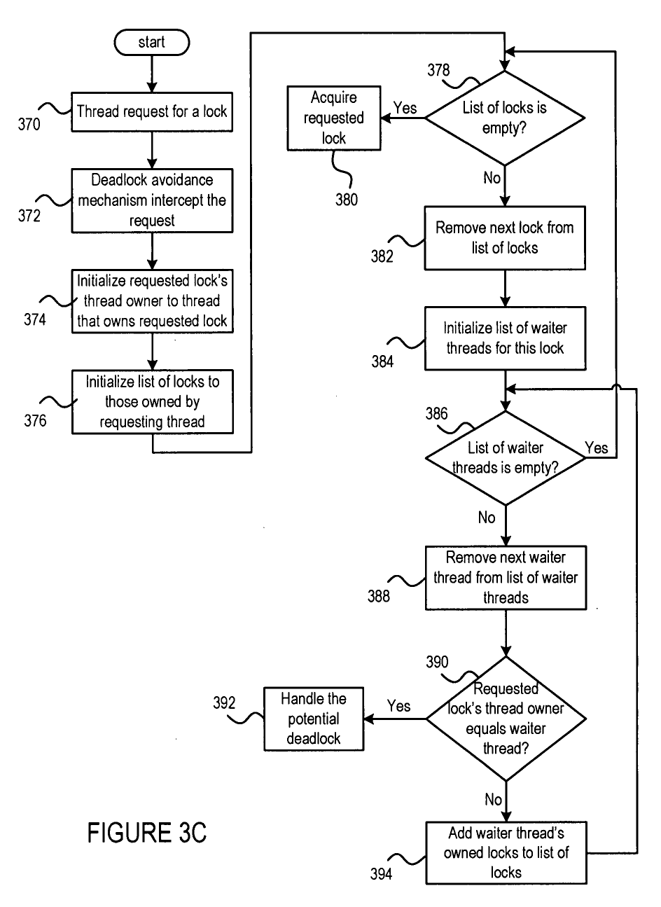

FIG. 3A shows, in an embodiment of the invention, a simple block diagram illustrating an implementation of a deadlock avoidance mechanism.

Consider the situation wherein, for example, an application process is being executed and a set of threads (thread 302 and 308) may be running. Threads 302 and 308 may possess a lock 304 and a lock 306, respectively (at time 1). Locks 304 and 306 may be mutual exclusion (mutex) locks. Each lock (e.g., lock 304 and lock 306) may only be owned by one application action at a time.

FIG. 3A will be discussed in relation to FIG. 3B. FIG. 3B shows, in an embodiment of the invention, a simple flow chart illustrating a method for implementing the deadlock avoidance mechanism. FIG. 3B is a simple but commonly found scenario that may be encountered in an application environment. However, the method described in FIG. 3B may be similarly applied in more complex scenario. The implementation of the deadlock avoidance mechanism is particularly advantageous in runtime environments in which the mechanism is invoked when an attempt is made to acquire a lock that already has an owner other than the thread requesting ownership.

At a first step 350, one of the threads may request ownership of a lock. In an example, thread 302 may request ownership of lock 306 (at time 2).

At a next step 352, a deadlock avoidance mechanism may intercept the request.

At a next step 354, the deadlock avoidance mechanism may check the thread to determine if the requesting thread currently possesses a lock. In this example, thread 302 currently possesses lock 304.

If the requesting thread does not currently possess a lock, then at a next step 356, the requesting thread may acquire the lock. Note that if the lock is available then the requesting thread may acquire ownership of the lock. However, if the lock is currently being held by another thread, then the requesting thread must wait until the lock is released before lock acquisition.

If the requesting thread currently possesses a lock, then at a next step 358, the deadlock avoidance mechanism may check to determine if the requested lock is available. In this example, thread 302 owns lock 304 and is requesting ownership of lock 306. Thus, the deadlock avoidance mechanism may now check to determine if the requested lock (lock 306) is currently available (i.e., not currently owned by another thread). In an embodiment, the deadlock avoidance mechanism may consult a table/database to determine a status of a lock. In an embodiment, the application layer may employ the interfaces available in virtualized OS layer 124 to query the status of the locks, the threads that own the locks, and the like.

If the requested lock is available, then the requesting thread may proceed to step 356 to acquire the lock.

However, if the requested lock is currently owned by a second thread, then at a next step 360, the deadlock avoidance mechanism may retrieve the identity of the thread that currently owns the requested lock. In this example, at time 2, the requested lock 306 is owned by thread 308. By focusing on analyzing only the thread that owns the lock that the requesting thread wants to acquire, the overhead cost of performing the analysis is kept at a minimum. Unlike the prior art, the processing may be performed at the application layer instead of the OS layer and may only have to query the virtualized OS layer for the required information.

At a next step 362, the deadlock avoidance mechanism may check to determine if the thread that owns the requested lock is waiting to acquire another lock. If the thread that owns the requested lock (e.g., thread 308) is not waiting to acquire another lock, the requesting thread (e.g., thread 302) may proceed to next step 356 to attempt to acquire the requested lock (e.g., lock 306). Note that the requesting thread may either get ownership of the lock or go into a sleep state to wait for the requested lock to be released. In this example, since the requested lock (lock 306) is currently owned by thread 308, thread 302 may go into a sleep state while waiting for thread 308 to release the requested lock as illustrated in time 3. Thus, thread 302 is now a blocked thread.

After a time period (at time 4), another thread may request ownership for a lock. In an example, thread 308 may now request ownership for lock 304. To prevent a deadlock situation, the deadlock avoidance mechanism may intercept the request and perform the checks described in the steps above. For example, the deadlock avoidance mechanism may analyze the requesting thread (thread 308) to determine if the requesting thread owns a lock. In this example, thread 308 currently owns lock 306. The deadlock avoidance mechanism may then check to determine if the requested lock is currently owned by another thread at next step 358. If the lock is currently owned by another thread, then the deadlock avoidance mechanism may proceed to next step 360 to find the identity of the thread that owns the lock. In this example, lock 304 is currently owned by thread 302. The deadlock avoidance mechanism may then analyze the thread (thread 302) to determine if the thread is waiting to acquire another lock at next step 362.

Since thread 302 is waiting to acquire another lock, at a next step 364, the deadlock avoidance mechanism may create a list of locks owned by the requesting thread. In this example, the list that has been created for thread 308 may include only lock 306.

At a next step 366, the deadlock avoidance mechanism may check to see if the lock waited on by the thread that owns the requested lock is in the list of locks owned by the requesting thread. In an embodiment, the deadlock avoidance mechanism is capable of discovering that the lock waited on by thread 302 is lock 306. Since lock 306 is in the list of locks owned by thread 308, the deadlock avoidance mechanism may proceed to next step 368 to handle the potential deadlock. However, if lock 306 is not on the list of locks owned by thread 308, then the deadlock avoidance mechanism may allow thread 308 to proceed to next step 356 to try to acquire lock 304.

In the prior art, the request from thread 308 may create a deadlock situation. However, with the deadlock avoidance mechanism, a deadlock situation has been circumvented and both threads have not entered into an uninterruptible state. In an example, thread 302 is in an uninterruptible state but thread 308 may be waiting in an interruptible state (time 5). In an embodiment, the deadlock avoidance mechanism employs the capabilities available in the virtualized OS layer, which enables the deadlock avoidance mechanism to function entirely in the user space without the necessity of making calls to the underlying operating system layer. Thus, a kill of the threads involved in the deadlock or a kill of the entire process containing the deadlock threads, both of which may leave the system in an inconsistent state and may require operating system state manipulation may be avoided.

TABLE 1
Multi-threads example

| Thread | Locks Owned | Waiting to Lock |
|---|---|---|
| Thread 1 | lock 1 | lock 2 |
| Thread 2 | lock 2 | lock 3 |
| Thread 3 | lock 3 | |

The previous description is for the simplest, most common type of deadlock, and the deadlock avoidance mechanism is extensible to handle more complex deadlock situations such as multiple threads participating in a deadlock as shown in Table 1 above. If thread 3 tries to acquire lock 1 then the system may deadlock. To extend the mechanism to such cases, the basic algorithm is modified to search the list of locks owned and the locks trying to be acquired by threads already in a waiting to lock state. The list information and execution state information is available from the virtualized OS layer.

FIG. 3C, shows in an embodiment, a simple flow chart that may be performed on systems with larger numbers of threads in which locks may be associated with one or more blocked threads in a potential circular chain (i.e., potential deadlock). Consider the situation wherein, for example, three threads are competing for the same resources (as shown in Table 2 above) and thread 3 is attempting to acquire lock 1.

TABLE 2
Step Situations and Results

| Step Situations | Results |
|---|---|
| Lock 1 available? | No, currently owned by thread 1 |
| Thread 3 owns a lock? | Yes, currently owns lock 3 |
| Thread 1 trying to acquire locks? | Yes, currently waiting on lock 2 |
| Lock 2 owned by thread 3? | No, currently owned by thread 2 |
| Thread 2 trying to acquire locks? | Yes, currently waiting on lock 3 |
| Lock 3 owned by thread 3? | Yes |

In this example, threads 1 and 2 are currently in a sleep state because each thread is waiting for a lock to be released. If thread 3 decides to make a request for lock 1, the deadlock avoidance mechanism may intercept the attempt to acquire lock 1 and employ the steps described in FIG. 3C to prevent a deadlock situation. As can be seen by the step situations described in Table 2 above, the deadlock avoidance mechanism may follow through and analyze each thread that may potentially cause the requesting thread (thread 3) to be in a deadlock situation.

At a first step 370, thread 3 may request for a lock (e.g., lock 1).

At a next step 372, a deadlock avoidance mechanism may intercept the request.

At a next step 374, the deadlock avoidance mechanism may initialize a variable that may hold a value used to identify the thread owning the requested lock. In this example, the identity of the thread owning the lock trying to be acquired by thread 3 is thread 1. The stored identity value may later be compared with identity of the threads waiting for other locks at next step 390.

At a next step 376, the deadlock avoidance mechanism may initialize a data structure that represents a list of locks to the set of locks owned by the thread requesting the lock. In one implementation, the list of locks may be obtained by querying the API for obtaining thread information based on the thread identity stored at step 374. In this example, the list may include a list with a single element, lock 3.

At a next step 378, the deadlock avoidance mechanism checks to determine if the list of locks is empty.

If the list of locks is empty, then at a next step 380, the requesting thread (e.g., thread 3) may acquire the requested lock (e.g., lock 1).

However, if the list of locks is not empty, as is the case in this example, then at a next step 382, the deadlock avoidance mechanism may remove a lock from the list of locks for additional analysis. The selected lock may be assigned to a local variable. In this example, the value of the selected lock is lock 3.

At a next step 384, the deadlock avoidance mechanism may initialize a data structure that represents a list of threads that are waiting to lock the selected lock. A virtualized OS layer may provide a method of obtaining the list of threads waiting to lock a specified lock. The threads waiting to lock a thread may also be referred to as “waiter threads.” In this example, thread 2 is waiting to acquire lock 3.

At next step 386, the deadlock avoidance mechanism may determine if the list of waiter threads is empty. In other words, whether there are threads waiting to lock the selected lock. In this example, the list is not empty.

If the list of waiter threads is empty, then the method may return to step 378 to analyze the next lock. In other words, the thread that owns the lock may not participate in a deadlock as a result of owning the selected lock since no thread is waiting to lock the selected lock.

However, if the list of waiter threads is not empty, then at a next step 388, the deadlock avoidance mechanism may remove a waiter thread from the list of waiter threads for additional analysis. The selected waiter thread may be assigned to a local variable. In the example, thread 2 may be removed from the list for additional analysis.

At a next step 390, the deadlock avoidance mechanism may determine if the value used to identify the thread owning the requested lock, obtained in step 374, is the same as the identity of the selected waiter thread. In this example, the value of thread 1 is compared to the value of thread 2, the identity of the waiter thread.

If the thread that owns the requested lock is the same as the waiter thread, then at a next step 392, the deadlock avoidance mechanism may handle the potential deadlock.

However, if the thread that owns the requested lock is not the waiter thread, then at a next step 394, the deadlock avoidance mechanism adds the waiter thread's owned locks to the list of locks for analysis. In this example, since the waiter thread (e.g., thread 2) is not the same as the thread that owns the requested lock (e.g., thread 1), the locks (e.g., lock 2) owned by thread 2 are added to the list of locks.

Steps 378 through 394 are iterative steps that illustrate the algorithm for handling multiple threads in a potential complex deadlock situation. In this example, lock 2 may be analyzed next at step 382. At next step 384, thread 1 is identified as the waiter thread. When comparison is performed at next step 390 between the identity of the thread owning the requested lock (e.g., thread 1), and the identity of the waiter thread (e.g., thread 1), the two identities are identical. As a result, the thread may proceed to a next step 392 to handle the deadlock.

The deadlock avoidance mechanism described in FIG. 3A, 3B and 3C provide an efficient and effective method for preventing deadlock. By preventing a thread from entering into an uninterruptible state, the method may avoid the undesirable task of manipulating the operating system in order to kill an application program.

In an embodiment, the deadlock avoidance mechanism may be dynamically turned on once a deadlock situation has been detected for an application program. Consider the situation wherein, for example, an application program may have four instances of an application running in a cluster of processes. During the execution of the application program, the deadlock avoidance mechanism may be inactive. Assume that the first instance of the application program detects a deadlock situation. Prior to killing the first instance of the application program, the deadlock avoidance mechanism is dynamically turned on for the other three instances of the application program. Further, upon restarting, the first instance is now running with the deadlock avoidance mechanism turned on. In an embodiment, the deadlock avoidance may be turned off for all instances once the problem has been diagnosed and a patch applied to the running instances of the application program. By dynamically controlling the deadlock avoidance mechanism, the overhead cost of implementing the deadlock avoidance mechanism may be significantly reduced while avoiding deadlocking the overall program.

In an embodiment of the invention, the deadlock avoidance mechanism described in FIG. 3A, 3B, and 3C may be implemented as a mechanism for preventing a lock in which a thread may be waiting for another event to occur. In other words, the deadlock avoidance mechanism is not limited to only detecting deadlocks that may occur due to locks. In general, the deadlock avoidance mechanism may be implemented to handle any application program action that may be waiting for another event to happen. In an embodiment, the event may be the acquisition of a lock. In another embodiment, the event may be an input/output operation such as a return of an SQL query. Similar to a lock situation, competing threads are in a wait state and neither threads may progress until the pending events (e.g., input/output operations) have completed execution.

The next few figures will illustrate embodiments for handling potential deadlock situations identified by a deadlock avoidance mechanism.

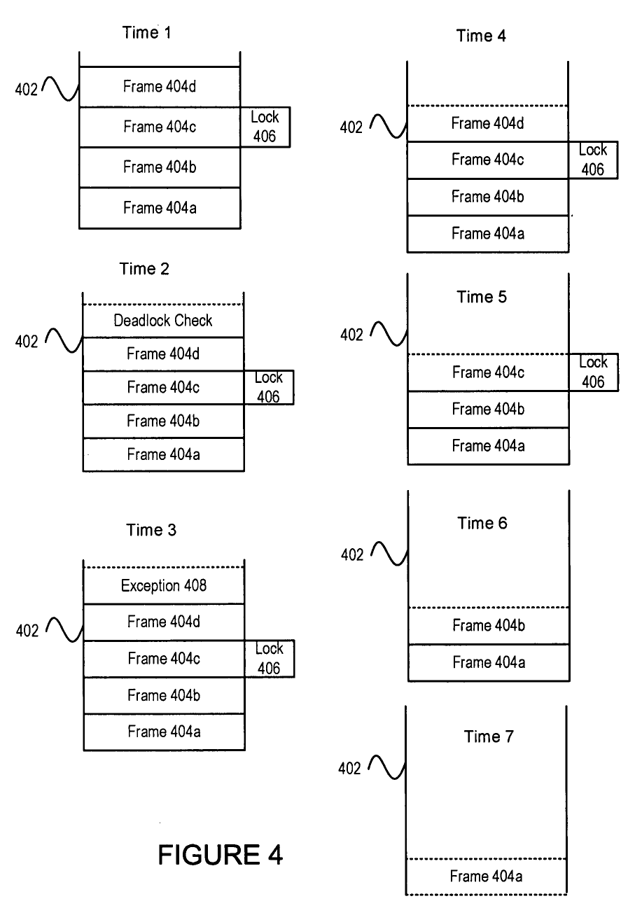

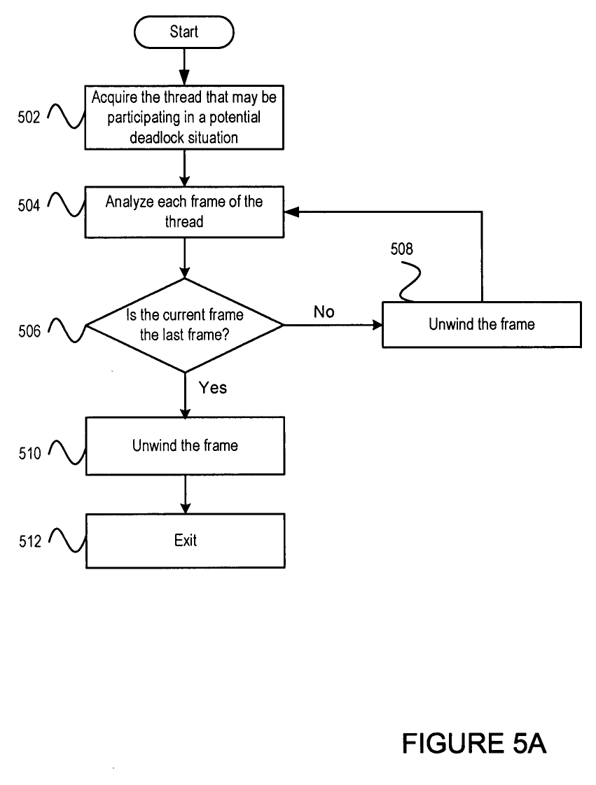

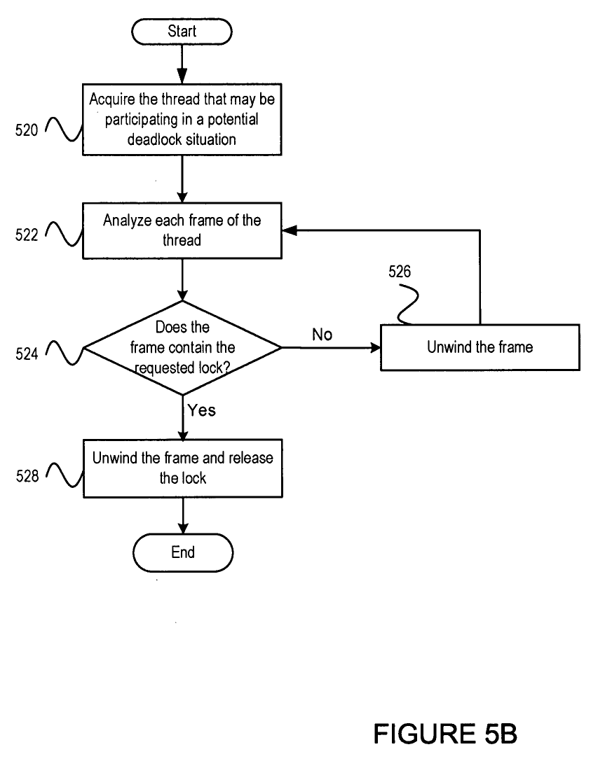

FIG. 4 shows, in an embodiment, a simple block diagram illustrating an automatic method that may be implemented to handle potential deadlock situation. FIG. 4 will be discussed in conjunction with FIG. 5A and 5B, which are simple flow charts for implementing the automatic method.

Consider the situation wherein, for example, a thread 402 with a lock 406 (at time 1) is performing a set of function calls, which may be represented by a plurality of frames (frame 404a, frame 404b, frame 404c, and frame 404d). At frame 404d, a request for another lock is made. Before the lock is acquired by thread 402, a deadlock avoidance mechanism may intercept the request and may perform various checks as described in FIG. 3B and 3C to determine whether attempting to acquire the lock may result in a deadlock (at time 2).

If attempting to acquire the lock may result in a deadlock, then an exception 408 (at time 3) may be generated in thread 402 to initiate exception handling. In an embodiment, the virtualized OS layer in conjunction with the operating system layer (e.g., runtime operating system) may perform the exception handling. In an embodiment, the exception handling may include unwinding each frame. Note that the frame 404d for the method/function on the stack corresponds to a section of code that may have been attempting to obtain a lock before entering a critical section.

A normal return to the method/function may result in the execution of the machine instructions corresponding to the code in the critical section. However, return to the machine instructions that correspond to frame 404d at transition from time 3 to time 4 may result in a return point that is a catch or finally clause, instead of to the critical section guarded by the locks. Return to one of the catch or finally clauses as a return point permits the user who implemented the code to clean-up the problems that may have occurred as the result of the exception. Furthermore, in the transition from time 5 to time 6, the exception handling may release lock 406, which is associated with frame 404c. By employing automatic release of locks held by threads, catch, and finally clauses for cleaning up sections of code that are executing instructions protected by locks, the automatic method provides proper recovery for unwinding, supports interruptible programming and permits the overall state of the program to remain consistent.

FIG. 5A shows, in an embodiment of the invention, a simple flow chart illustrating a method for unwinding a thread. At a first step 502, the runtime operating system (OS) and/or virtualized OS layer may acquire the thread that may be participating in a potential deadlock situation. In this example, thread 402 is acquired.

At a next step 504, the runtime OS and/or virtualized OS layer may analyze each frame of the thread. In the analysis phase, user executable code in exception handling related constructs such as catch and finally clauses may be executed. Similarly, the runtime OS and virtualized OS layer may execute code that may release one or more locks associated with the frame and associated executable instructions.

At a next step 506, the runtime OS may examine each frame to determine if the current frame is the last frame in the thread.

If the current frame is not the last frame, then at a next step 508, the runtime OS may unwind the frame and return to step 504.

However, if the current frame is the last frame, then at a next step 510, the runtime OS may unwind the frame and proceed to a next step 512 to exit the unwinding process.

FIG. 5A illustrates a method that may unwind a thread until each frame has been unwound. In an embodiment, the unwinding method may occur up until the requested lock has been unwound, as shown in FIG. 5B.

Similar to steps 502 and 504, next steps 520 and 522 may include acquiring the thread that may be participating in a potential deadlock situation and performing analysis on each frame. Also, during the analysis phase, user executable code in exception handling related constructs such as catch and finally clauses may be executed.

At a next step 524, the runtime OS may analyze a frame to determine if the frame includes the requested lock. At this point, the runtime OS may execute code that releases one or more locks associated with the frame and associated executable instructions.

If the current frame does not include the requested lock, then at a next step 526, the runtime OS may unwind the frame and return to step 522.

However, if the current frame does include the requested lock, then at a next step 528, the frame is unwound and the requested lock is released. In an embodiment, the requested lock may be acquired by the waiting thread as soon as the lock has been released.

In an embodiment, unwinding of a frame may include built-in mechanism (e.g., bytecode instrumentation, interruption policy, etc.) for insuring auto recovery, maintaining consistency of the application, and minimizing the loss of data. In other words, the data values may be validated and corrected, if necessary, in order to assure that the state of the application program remains consistent. In an example, a thread may have made changes to a database. In the unwinding process, the database may be restored back to its original state in order to minimize the potential for data corruption. In an embodiment, the automatic method may log the problem for later analysis.

The methods described in FIG. 4, 5A, and SB are examples of automatic solutions for handling potential deadlocks. The methods may be implemented without human intervention. Also, the methods are inexpensive solutions that may be implemented without requiring high overhead cost.

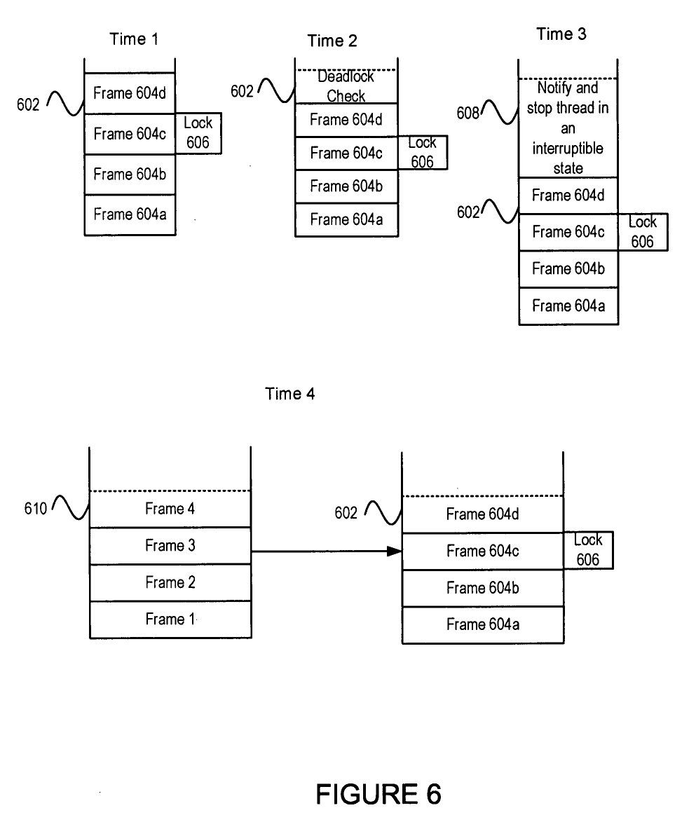

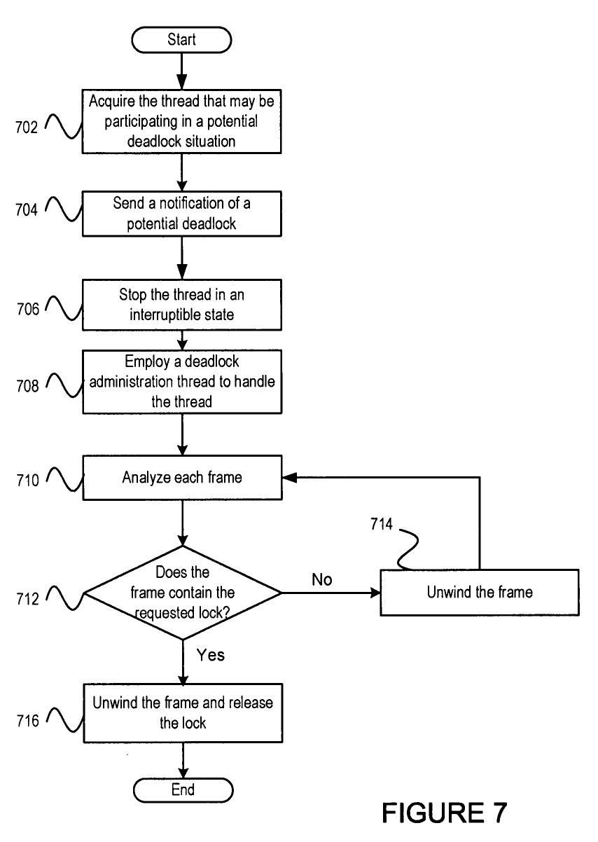

FIG. 6 shows, in an embodiment of the invention, a simple block diagram illustrating a user notification method for handling potential deadlock situation. FIG. 6 will be discussed in relation to FIG. 7, which shows a simple flow chart example of the method described in FIG. 6.

Consider the situation wherein, for example, a thread is performing a set of method or function calls. Similar to FIG. 4, a thread 602 may own a lock 606 (time 1). In FIG. 6, the function calls may be represented by a plurality of frames (frame 604a, frame 604b, frame 604c, and frame 604d). As time progresses, thread 602 may want to acquired another lock (e.g., lock 2), which is currently owned by another thread (e.g., thread 2). At frame 604d, a request for another lock is made. Before lock 2 is acquired by thread 602, a deadlock avoidance mechanism may intercept the request and may perform various checks as described in FIG. 3B and 3C to identify a potential deadlock situation (time 2). In an example, the deadlock avoidance mechanism may have identified that thread 2 is already waiting to acquire lock 606. Thus, if the deadlock avoidance mechanism had not intercepted the call, a deadlock situation may exist between thread 602 and thread 2.

FIG. 7 shows, in an embodiment of the invention, a simple flow chart for implementing the user notification method. At a first step 702, the runtime operating system may acquire the thread that may be participating in a potential deadlock situation. In this example, thread 602 is acquired.

At a next step 704, a notification of a potential deadlock may be sent to the system administrator and/or the log file (time 3 of FIG. 6). In an example, a notification 608 may be sent.

At a next step 706, the thread (e.g., thread 602) may be stopped in an interruptible state.

At a next step 708, a deadlock administration thread (610) may be employed to perform checks on the potential deadlock thread (e.g., thread 602) to determine the best method for handling the potential deadlock situation. In an embodiment, the deadlock administration thread (610) may be manually managed by a human and/or by a system program. In an embodiment, the threads in the potential deadlock situation may be analyzed to determine which thread performs the least critical function. In other words, if thread 602 is performing a critical function, the thread (e.g., thread 2) that currently owns the lock that thread 602 is trying to acquire may be the one that is unwound.

At a next step 710, the deadlock administration thread (610) may analyze each frame of the thread.

At a next step 712, the deadlock administration thread (610) may examine a frame to determine if the frame includes the requested lock (e.g., lock 606).

If the current frame does not include the requested lock (e.g., lock 606), then at a next step 714, the runtime OS may unwind the frame and return to step 710.

However, if the frame does include the requested lock (e.g., lock 606), then at a next step 716, the frame is unwound and the requested lock (e.g., lock 606) is released. Note that more than one frame of a thread may hold the same lock; thus, the runtime OS may unwind the thread until all frames that hold the lock have been unwound. Once the lock has been released, in an embodiment, the requested lock (e.g., lock 606) may be acquired by the waiting thread (e.g., thread 2) as soon as the lock has been released.

In an embodiment, unwinding of a frame may include steps for insuring consistency of the application. In other words, the data values may be validated and corrected, if necessary, in order to assure that the state of the application program remain constant. In an embodiment, each frame of the thread may be unwound until all frames have been unwound. In the notification method, the decision to unwind all or only part of the thread may be decided by the administrator. In an embodiment, the deadlock event notification method may log the problem for later analysis.

As can be appreciated from the forgoing, one or more embodiments of the present invention provide for a deadlock avoidance mechanism for identifying potential deadlock situation. The deadlock avoidance mechanism is a lightweight inexpensive solution that may be implemented in substantially most computer operating environments. Also, since a deadlock situation has been avoided, a thread is never put into an uninterruptible sleep state. Thus, the threads may be handled without having to alter the internal state of an operating system (e.g., manually releasing the locks that are held, cleaning up the internal data structures, terminating the processes/threads, etc.)

While this invention has been described in terms of several preferred embodiments, there are alterations, permutations, and equivalents, which fall within the scope of this invention. Also, the title, summary, and abstract are provided herein for convenience and should not be used to construe the scope of the claims herein. It should also be noted that there are many alternative ways of implementing the methods and apparatuses of the present invention. Although various examples are provided herein, it is intended that these examples be illustrative and not limiting with respect to the invention. Further, in this application, a set of “an” items refers zero or more items in the set. It is therefore intended that the following appended claims be interpreted as including all such alterations, permutations, and equivalents as fall within the true spirit and scope of the present invention.

What is claimed is:

1. A computer-implemented method for implementing a deadlock avoidance mechanism to prevent a plurality of threads from deadlocking in a computer system wherein a first thread of said plurality of threads request for a first resource, comprising:
employing said deadlock avoidance mechanism to intercept said request;
examining a status of said first resource;
if said first resource is owned,
identifying an owner of said first resource,
analyzing said owner of said first resource to determine if said owner of said first resource is requesting a second resource, and
analyzing said second resource to determine if said second resource is owned by said first thread; and
if said first thread owns said second resource, preventing deadlocking by handling a potential deadlock situation.

2. The computer-implemented method of claim 1 wherein said deadlock avoidance mechanism representing a set of executable code that is executable by each thread of said plurality of threads.

3. The computer-implemented method of claim 1 wherein said first resource is a lock.

4. The computer-implemented method of claim 3 wherein said lock is a mutual exclusion lock (mutex).

5. The computer-implemented method of claim 1 wherein said deadlock avoidance mechanism includes a mechanism for verifying availability of said first resource by analyzing data available in a virtualized operating system layer.

6. The computer-implemented method of claim 1 wherein said deadlock avoidance mechanism is executed in a user mode privilege level.

7. The computer-implemented method of claim 1 wherein said handling said potential deadlock situation includes unwinding at least one frame of a plurality of frames for a stack of said first thread, said unwinding including undoing said at least one function call of a plurality of function calls for said stack of said first thread.

8. The computer-implemented method of claim 7 wherein said unwinding is configured to stop when ownership of said first resource is released.

9. The computer-implemented method of claim 1 wherein said handling said potential deadlock situation includes employing a deadlock event notification method, said deadlock event notification method including
sending a notification to an administrator of said potential deadlock situation, and
employing a deadlock administration thread to handle said potential deadlock situation.

10. The computer-implemented method of claim 1 wherein said handling of said potential deadlock situation is configured to be based on a function of a thread,
if said first resource provides a higher function, said second resource is selected for said handling, and
if said second resource provides a higher function, said first resource is selected for said handling.

11. An article of manufacture comprising a program storage medium having computer readable code embodied therein, said computer readable code being configured to implement a deadlock avoidance mechanism for identifying potential deadlocks in a computer system, comprising:
computer readable code for employing said deadlock avoidance mechanism to intercept a request from a first thread from a plurality of threads for a first resource;
computer readable code for examining a status of said first resource;
if said first resource is owned,
computer readable code for identifying an owner of said first resource,
computer readable code for analyzing said owner of said first resource to determine if said owner of said first resource is requesting a second resource, and
computer readable code for analyzing said second resource to determine if said second resource is owned by said first thread; and
if said first thread owns said second resource, computer readable code for preventing deadlocking by handling a potential deadlock situation.

12. The article of manufacture of claim 11 wherein said deadlock avoidance mechanism representing a set of executable code that is executable by each thread of said plurality of threads.

13. The article of manufacture of claim 11 wherein said first resource is a lock.

14. The article of manufacture of claim 13 wherein said lock is a mutual exclusion lock (mutex).

15. The article of manufacture of claim 11 wherein said deadlock avoidance mechanism includes a mechanism for verifying availability of said first resource by analyzing data available in a virtualized operating system layer.

16. The article of manufacture of claim 11 wherein said deadlock avoidance mechanism is executed in a user mode privilege level.

17. The article of manufacture of claim 11 wherein said handling said potential deadlock situation includes computer-readable code for unwinding at least one frame of a plurality of frames for a stack of said first thread, said computer-readable code for unwinding including undoing said at least one function call of a plurality of function calls for said stack of said first thread.

18. The article of manufacture of claim 17 wherein said computer-readable code for unwinding is configured to stop when ownership of said first resource is released.

19. The article of manufacture of claim 11 wherein said handling said potential deadlock situation includes computer-readable code for employing a deadlock event notification method, said deadlock event notification method including
computer-readable code for sending a notification to an administrator of said potential deadlock situation, and
computer-readable code for employing a deadlock administration thread to handle said potential deadlock situation.

20. The article of manufacture of claim 11 wherein said computer-readable code for handling said potential deadlock situation is configured to be based on a function of a thread,
if said first resource provides a higher function, said second resource is selected for said handling, and
if said second resource provides a higher function, said first resource is selected for said handling.
